(19) United States
(12) Patent Application Publication
(10) Pub. No.: US 2020/0183973 A1
(43) Pub. Date: Jun. 11, 2020

(54) Methods of Fingerprint-Based Watermarking of Audio Files

(71) Applicant: Himeta Technologies S.p.r.l., Evere (BE)

(72) Inventors: Youri Balcers, Evere (BE); Jimmy Nsenga, Brussels (BE); Jean-Jacques Quisquater, Rhode St. Genese (BE)

(21) Appl. No.: 16/614,646

(22) PCT Filed: May 21, 2018
(86) PCT No.: PCT/IB2018/000644

§ 371 Date: Nov. 18, 2019

Related U.S. Application Data
(60) Provisional application No. 62/508,727, filed on May 19, 2017.

(51) Int. Cl. G06F 16/683; G06F 16/635; G10L 19/018; G06F 21/16

(52) U.S. Cl. CPC G06F 16/683; G06F 21/16; G10L 19/018; G06F 16/635

(57) ABSTRACT

A new watermarking concept is presented. The method exploits audio fingerprinting in order to reuse the same watermark payloads between audio copies originating from different audio masters. This is achieved by using fingerprints of audio master to derive unique watermarking zones for its associated copies, therefore obviating the need of adding overhead synchronization bits to locate watermark positions. Thanks to a shorter watermark payload enabling a higher repetition rate of the watermark within the host media, the present methods have been validated via simulations to be robust against typical audio attacks such as MP3 compression, cropping, jittering, and zeros inserting.

### CROSS-REFERENCE TO RELATED APPLICATIONS

This application claims priority to U.S. Provisional Application No. 62/508,727, filed on May 19, 2017, now pending, the disclosure of which is incorporated herein by reference.

### FIELD OF THE DISCLOSURE

This disclosure relates to watermarks for digital files, and in particular, digital audio files.

### BACKGROUND OF THE DISCLOSURE

According to the International Federation of the Phonographic Industry (IFPI), in 2015 digital music sales became the leading revenue stream generating globally around US $6.7 b, with a projection of US $20 b by 2020. This growth is a result of Internet advances in the distribution of digital contents, including multimedia. Unfortunately, this progress also creates an unprecedented challenge for authenticating the resulting several billion instances of licensed audio content, mainly distributed via the Internet. One of the associated business scenario that is considered in this disclosure is the tracking of audio copies broadcasted on web radio, with a requirement to identify both the audio master title and the owner of a given particular audio copy being played.

Digital watermarking is a well-known solution for audio tracking and authentication. It includes embedding hidden inaudible data into host audio. Several algorithms have been proposed in the literature and some of these algorithms are in current use in commercial services such as NexGuard, MusicTrace, and the like. However, such existing techniques rely on embedding a unique watermark payload in every distributed audio copy. With several billion copies of audio content to be tracked, the resulting number of bits required to encode all potential unique watermarks is very large. Such large payloads increase the risk that audible distortion will result from the watermark having been embedded in the copy. This problem has stimulated strong research interest around “high payload audio watermarking.”

As a result, there is a long-felt need for improved watermarking technology which lowers the risk of problems such as audible distortion.

### BRIEF SUMMARY OF THE DISCLOSURE

This disclosure presents a new watermarking concept that exploits audio fingerprinting in order to reuse the same watermark payloads between audio copies originating from different audio masters. This is achieved by using fingerprints of audio master to derive unique watermarking zones for its associated copies, therefore obviating the need of adding overhead synchronization bits to locate watermark positions. Thanks to a shorter watermark payload enabling a higher repetition rate of the watermark within the host media, the present methods have been validated via simulations to be robust against typical audio attacks such as MP3 compression, cropping, jittering, and zeros inserting.

### DESCRIPTION OF THE DRAWINGS

For a fuller understanding of the nature and objects of the disclosure, reference should be made to the following detailed description taken in conjunction with the accompanying drawings, in which:

FIG. 1 is a system-level diagram of the presently-disclosed fingerprint-based watermarking techniques;

FIG. 2 is a diagram of a fingerprint-based watermark embedder according to an embodiment of the present disclosure;

FIG. 3 is a diagram of an embodiment of watermark embedding based on a hybrid frequency hopping/time hopping (FH/TH) spread spectrum (SS) technique;

FIG. 4 is a diagram of an embodiment of a fingerprint-based watermark detector;

FIG. 5 is a diagram of an embodiment of watermark extraction based on cross-correlation synchronization and spread spectrum demodulation;

FIG. 6 depicts a flowchart of a method for generating a watermarked audio copy of an audio signal according to an embodiment of the present disclosure;

FIG. 7 is a continuation of the portion of FIG. 6 at ‘A’;

FIG. 8 is a continuation of the portion of FIG. 6 at ‘B’;

FIG. 9 is a continuation of the portion of FIG. 6 at ‘C’; and

FIG. 10 is a flowchart of a method of retrieving information of an audio copy of an audio signal according to another embodiment of the present disclosure.

### DETAILED DESCRIPTION OF THE DISCLOSURE

In computer science, fingerprinting is a procedure that maps an arbitrarily large data item (such as a computer file) to a much shorter bit string, its fingerprint, that uniquely identifies the original data. For an audio signal, such as an audio file, an acoustic fingerprint is a condensed digital summary, deterministically generated from the audio signal, that can be used to identify an audio sample or quickly locate similar items in an audio database.

A digital watermark is a kind of marker covertly embedded in a noise-tolerant signal such as an audio. “Watermarking” is the process of hiding digital information in a carrier signal. Digital watermarks may be used to verify the authenticity or integrity of the carrier signal or to show the identity of its owners.

For the purposes of the present disclosure, an audio master is an audio file (e.g., song or any other audio sample) in its original format, without any watermark. An audio copy is a copy of an audio master, where the copy includes an embedded watermark. Two different copies will have the same carrier signal (e.g., song) but different watermarks. A clone is an exact copy of an audio file, including any embedded signal. Two clones are identical and do not differ in any aspect from the signals point of view.

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure.

Fingerprinting may include extracting features and/or patterns from a known audio signal and storing the features and/or patterns, associated with the known audio signal, in a database. The database may then be queried to identify an unknown audio signal by matching the fingerprints of this unknown signal with those already stored in the database. Fingerprinting cannot distinguish audio copies of the same audio master because the audio copies will have similar fingerprints. However, fingerprinting is advantageous in that information about the audio signal can be retrieved without the need to embed data into the signal—i.e., an empty watermark payload.

In the presently-disclosed approach, non-unique watermarks are used in conjunction with fingerprinting to reduce the number of bits necessary to encode the watermark payload. A shorter watermark yields two main advantages. First, the risk of audibility is lower (the risk that the embedded watermark will be noticeable to a listener). Second, the watermark may be more frequently repeated within the audio signal to improve the watermark extraction robustness by aggregating the watermark signal across several frames. Practically speaking, the present solution collects fingerprints of audio masters and uses these fingerprints to derive unique zones for the corresponding audio master, where the zones are used for placing watermarks in related copies. Additionally, by positioning watermarks based on fingerprints, there is no need to include overhead synchronization bits to locate watermark positions.

The presently-disclosed methods are advantageous in various respects, including:
Blind: This is no requirement for audio masters or distributed audio copies to be available during the watermark detection process.
Imperceptible: This is achieved on the one hand by reducing the number of bits required to encode the watermark payload thanks to watermark payload reusability. On the other hand, the watermark signal is embedded into the host signal using spread spectrum modulation. This enables a watermark signal having small amplitudes—generally, less than the noise level.
Robust: Thanks to using a short watermark payload, its repetition rate within the audio copy may be increased in order to get more energy by aggregating the watermark signal across several frames during watermark extraction.
Low cost watermark synchronization: Watermarks can be placed on audio master fingerprints; thus there is no need to include overhead synchronization bits to locate watermark positions as long as the fingerprints are recovered. Furthermore, fingerprints are robust to audio attacks.
Secure: The watermarking positions (zones) are defined based on a pseudo-random sequence, which seed state is initiated by the master ID of audio master.
Variable Size Watermark Payload: The watermark payloads need only be different between audio copies of the same audio master and not between audio copies from different audio masters. Therefore, the number of bits required to encode the watermark may be customized for each audio master, since different masters have different numbers of potential copies to be created.

### FINGERPRINT-BASED WATERMARKING

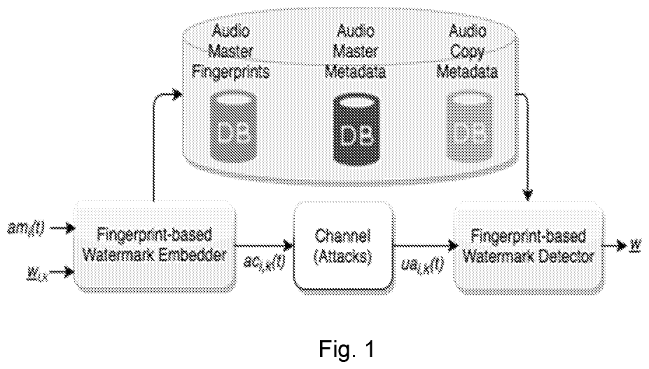

FIG. 1 shows a system-level diagram of the present fingerprint-based watermarking technique. FIG. 1 depicts a watermark embedder that receives as inputs: (1) an audio master signal (amₜ(t): the i^{th} audio signal); and (2) a vector of bits (w̅_{i,k}) representing the watermark payload of the k^{th} copy of the i^{th} audio master signal. Note that in some embodiments, ∀i: w̅_{i,k}=w̅ₖ—i.e., all the k^{th} copies of all audio masters have the same watermark payload. The watermark embedder will produce a watermarked audio copy of the audio master (ac_{i,k}(t): the k^{th} audio copy of the i^{th} audio master signal). FIG. 1 also depicts a watermark detector which can receive an unknown audio signal (ua_{i,k}(t): k^{th} copy of the i^{th} audio master signal), which may have been modified by one or more “channel attacks ” (such as MP3 compression, cropping, jittering, and zeros inserting) during or subsequent to distribution.

FIG. 1 also depicts a database which houses the following information:
“Audio Master Fingerprints”: unique features and/or patterns of audio masters that are used to identify the original audio master.
“Audio Master Metadata”: information about the audio master including, for example, the title, singer, album, etc. Each metadata set is associated to a unique ID called masterID.
“Audio Copy Metadata”: information about the audio copies including, for example, the embedded watermark payload (sequence of bits), copy owner, associated masterID, etc.

It should be noted that the above-described information may be housed in a single database file or more than one database files (in which case, the database comprises multiple databases). For example, the database of information may be embodied in three separate databases—the Audio Master Fingerprints database, the Audio Master Metadata database, and the audio Copy Metadata database. For convenience, the remainder of this disclosure will refer to this exemplary embodiment having three separate databases, but the scope should not be limited to only this embodiment.

### Fingerprint-Based Watermark Embedder

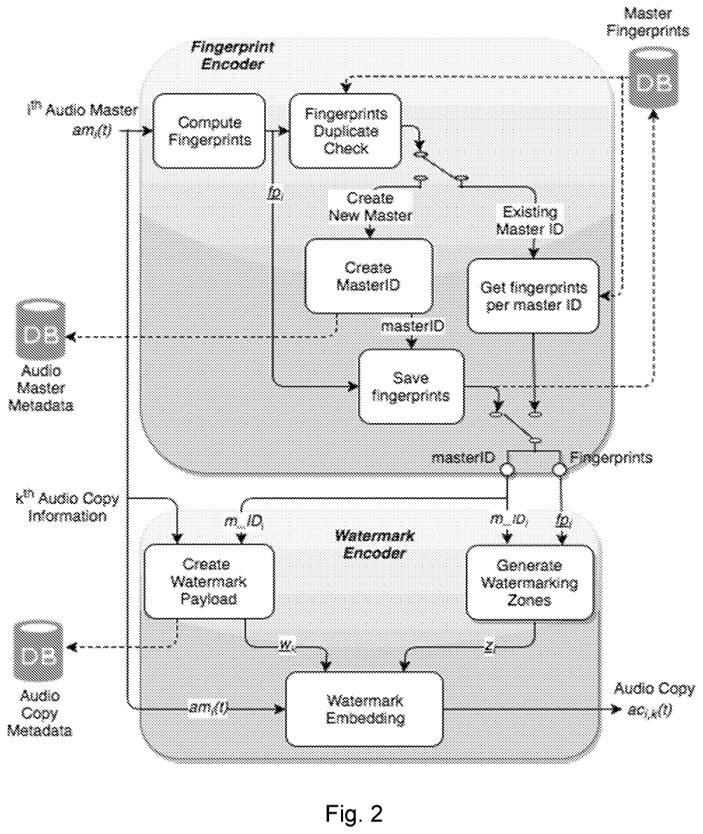

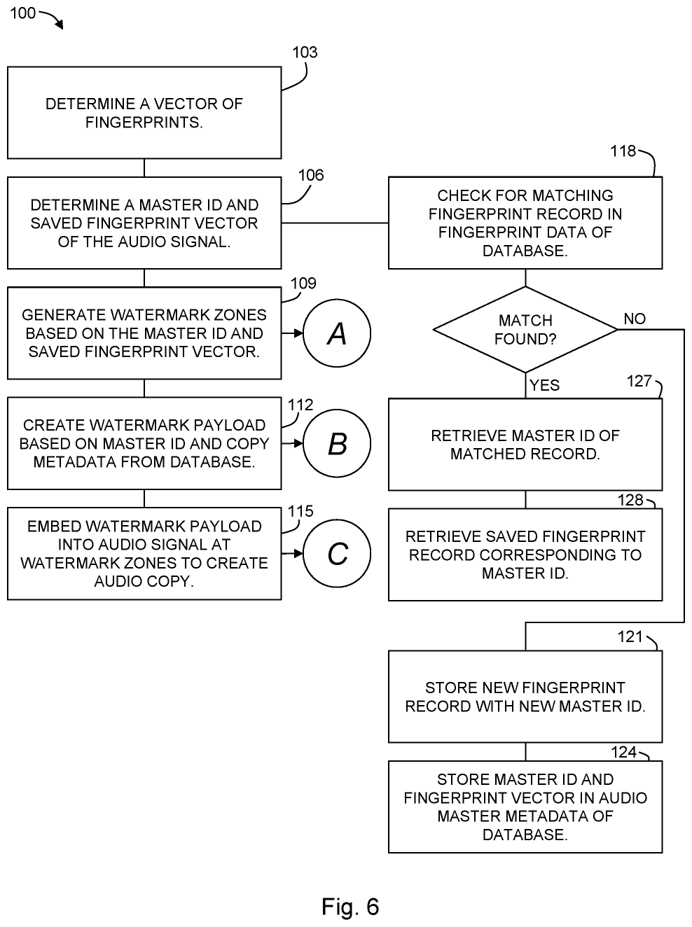

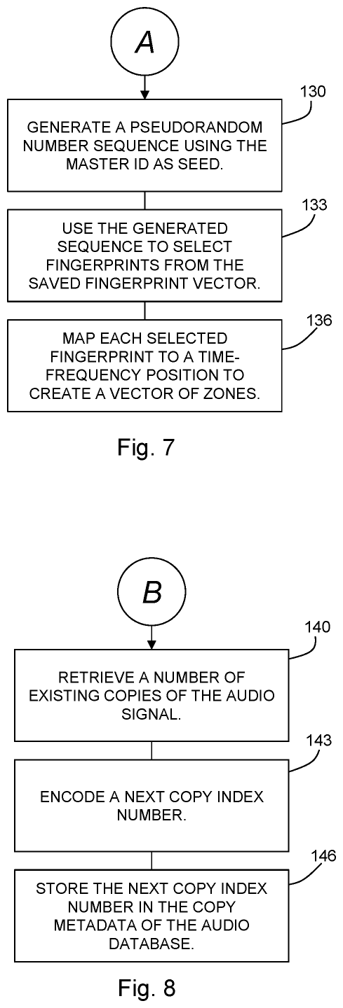

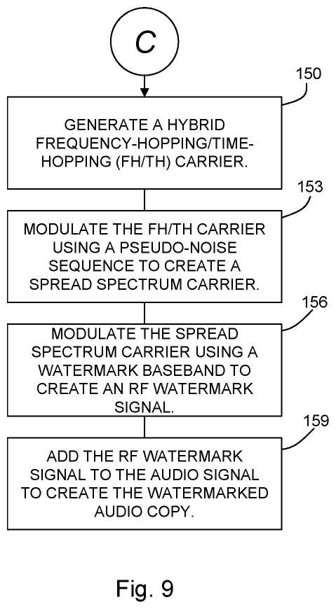

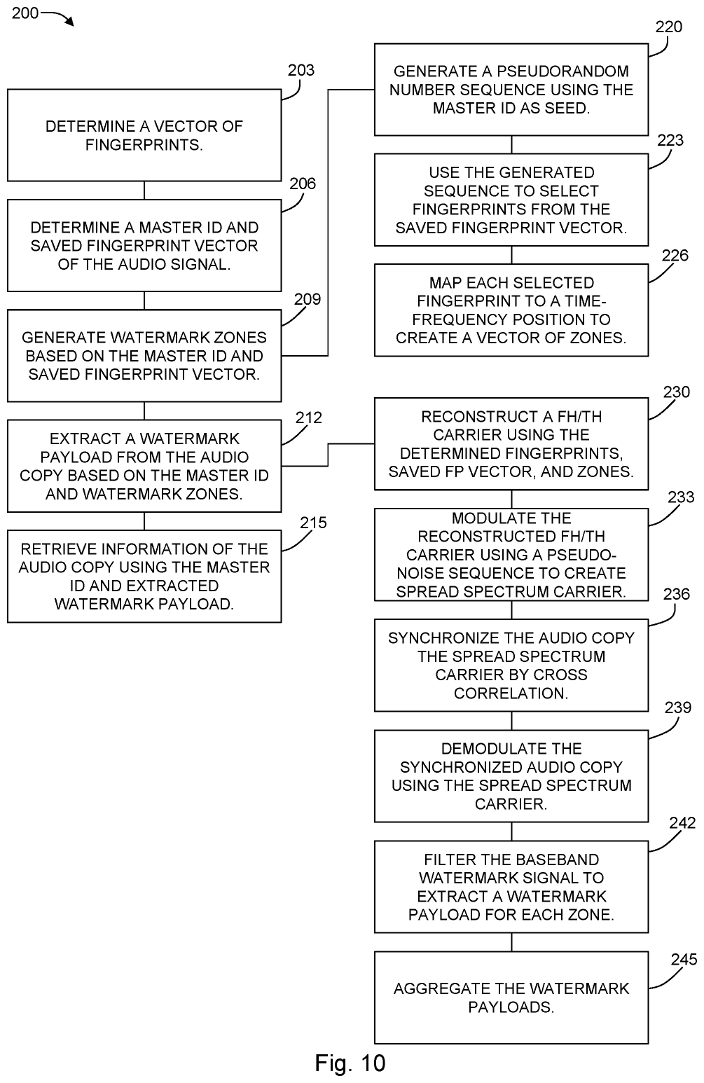

FIG. 2 shows a logic diagram of an exemplary watermark embedder according to an embodiment of the present disclosure. The diagram depicts the embedder as having two sub-components: a fingerprinting encoder and a watermarking encoder (though such a configuration is exemplary and not intended to be limiting). Reference is also made to FIG. 6, which depicts a method 100 for generating a watermarked audio copy of an audio signal.

### Fingerprint Encoder

Taking as input the i^{th} audio master signal, amᵢ(t), the role of the fingerprint encoder is to provide both the master ID (m_IDᵢ) and the vector of its fingerprints (f̅p̅ᵢ), which are then used by the watermarking encoder. A vector of fingerprints is determined 103 for the audio signal. Acoustic fingerprints of the audio signals can be computed in any manner. For example, fingerprints may be computed by creating a time-frequency graph—a spectrogram. After computing the fingerprints (i.e., determining 103 the vector of fingerprints), a master ID and saved fingerprint vector are determined 106 for the audio signal. For example, a check 118 is carried out to verify whether or not the fingerprints of the considered audio master are already stored as a record in the master fingerprints database. If the check fails (i.e., if there is no matching set of fingerprints in the database), a new record is created 121 including a master ID and the determined 103 vector of fingerprints. A new record is also created 124 in the audio master metadata database, where the record includes the master ID together with information about the considered audio master. If, on the other hand, the check matches the fingerprints to existing fingerprints stored in the master database, the corresponding master ID (m_ID₁) is returned 127, as well as the saved fingerprints 128 stored in the database for that particular audio master (returned as the vector f̅p̅ᵢ).

### Watermark Encoder

The role of the watermark encoder is to create the audio copy signal ac_{i,k}(t), denoting the k^{th} audio copy of the i^{th} master. This copy includes an embedded watermark payload, w̅_{i,k}. In the present embodiment, ∀i:w̅_{i,k}=w̅ₖ, meaning that all the k^{th} copies of all audio masters have the same watermark payload.

### Create Watermark Payload

A watermark payload is created 112 based on the master ID and using copy metadata retrieved from a database. For example, by using the master ID m_IDᵢ of the i^{th} audio master, the number of existing copies, denoted by ncᵢ, can be retrieved 140 from the Audio Copy Metadata Database. A watermark payload w̅ₖ of a new audio copy is created 112 by encoding 143 its copy index k=ncᵢ+1 on N_{bits}. The number of bits required to encode the watermark payload is calculated based on the potential maximum number of audio copies (Kₘₐₓ) for a single audio master. Since the presently-disclosed technique can reuse watermark payloads between copies from different audio masters, the number of bits required is small compared to the total sum of all copies for all masters Σᵢ₌₁^{I}^{ₘₐₓ}K_{max,i}, with Iₘₐₓ, and K_{max,i} denoting respectively the potential maximum number of all audio masters and the potential maximum number of audio copies for the i^{th} master. The audio copy index number may be stored 146 in the audio copy metadata.

### Generate Watermarking Zones

Watermarking positions (i.e., zones, represented as vector z̅ᵢ) are generated 109 based on the master ID, m_IDᵢ, and the saved fingerprint vector (f̅p̅ᵢ). First, a pseudorandom number sequence is generated 130 using m_IDᵢ to initiate the seed state. Then, the generated sequence is used 133 to select a subset of f̅p̅ᵢ. Then, each selected fingerprint is mapped 136 to a time-frequency position to get the vector of watermarking zones according to:

z̅ᵢ=[(t_{i,1}, f_{i,1}),(t_{i,2},f_{i,s}), . . . ,(t_{i,N}_{_{z}},f_{i,N}_{_{z}})], (1)

where the value N_{z} is the number of watermarking zones and represents the targeted repetition rate of the watermark payload within the audio copy to be generated.

It is also noted that by seeding the pseudorandom number sequence with m_IDᵢ, a deterministic (i.e., reproducible) random sequence can be generated for that particular audio master. Thus, during the watermark extraction operation, once the audio master associated to the unknown copy under analysis has been recognized, it is then possible to reconstruct exactly this sequence of original watermarking positions.

### Embedding Watermark

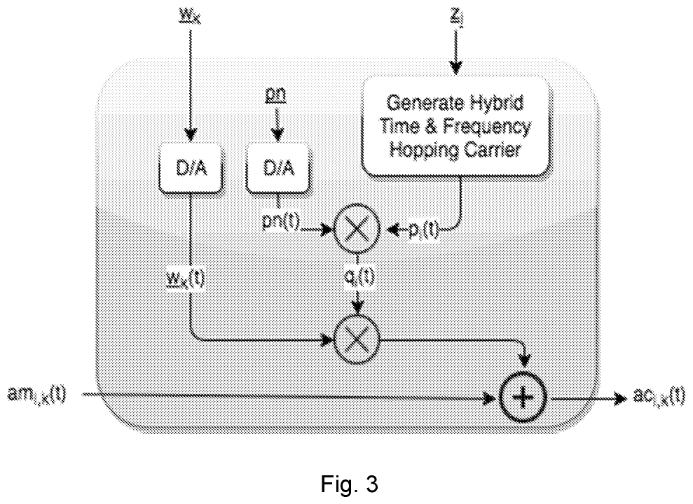

The created 112 watermark payload is then embedded 115 in the audio signal according to the generated 109 watermark zones. In this way, a watermarked audio copy of the audio signal is created. FIG. 3 shows an example of the watermark embedding process. It is based on a hybrid frequency-hopping/time-hopping (FH/TH) spread spectrum (SS) technique.

From the set of time-frequency watermarking positions, z̅ᵢ, a hybrid FH/TH carrier is generated 150, denoted by pᵢ(t), which is specific to the i^{th} audio master. It is mathematically expressed by:

$${p}_{i} ( t ) = {\sum }_{n = 1}^{{N}_{z}} {\int }_{{t}_{i , n} - \frac{Δ {T}_{i , n}}{2}}^{{t}_{i , n} + \frac{Δ {T}_{i , n}}{2}} {a}_{i , n} cos [ 2 π {f}_{i , n} ( t - {t}_{i , n} ) ] \qquad ( 2 )$$

where:
t_{i,n}, and f_{i,n} denote the time and frequency position of the n^{th} watermarking position for the i^{th} master, respectively;
ΔT_{i,n}=N_{bits}*R_{chip}*1/f_{i,n} is the time duration for transmitting the watermarking payload with a sinusoidal carrier of frequency f_{i,n}; and
a_{i,n} is the amplitude of the hybrid FH/TH carrier in the time range

$$[ {t}_{i , n} - \frac{Δ {T}_{i , n}}{2} , {t}_{i , n} + \frac{Δ {T}_{i , n}}{2} ] .$$

This amplitude is defined based on the energy of the audio master in the same time range, in order to keep the signal to watermark noise ratio the same.

The generated hybrid FH/TH carrier pᵢ(t) is modulated 153 by a pseudo-noise sequence to yield a spread spectrum hybrid FH/TH carrier qᵢ(t). The latter is then modulated 156 by a watermark baseband signal wₖ(t) to yield a radio frequency (RF) watermark signal. The k^{th} audio copy of the i^{th} master is obtained by (adding the RF watermark to the audio signal 159):

ac_{i,k}(t)=amᵢ(t)+wₖ(t)*qᵢ(t) (3)

By spreading the spectrum of the watermark payload signal, the latter is hidden in the host audio signal (i.e., is made imperceptible). Furthermore, this spreading process will enable the recovery of the watermark payload signal from the audio copy signal during the watermark detection process explained below.

### Fingerprint-Based Watermark Detector

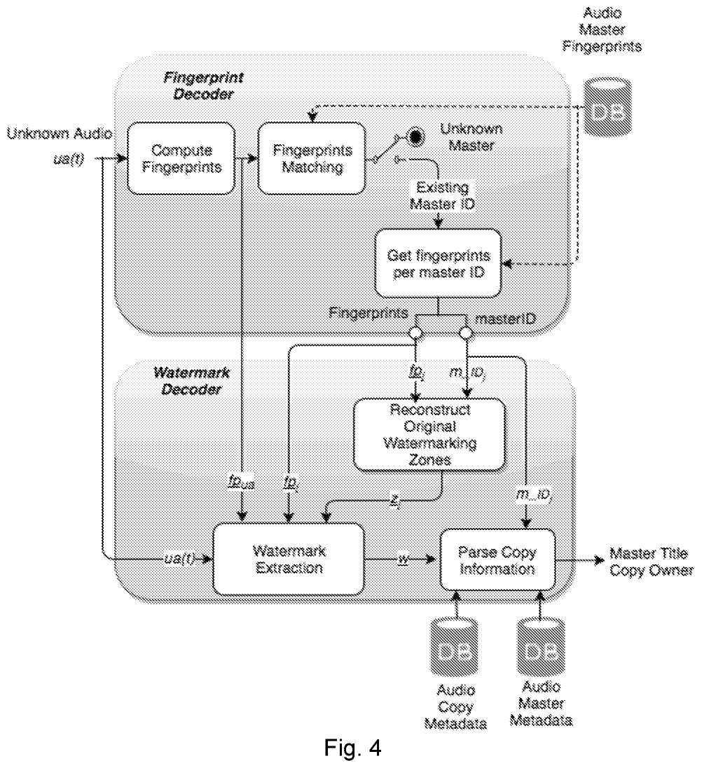

Let us consider an unknown audio that has to be verified and denoted by ua(t). This audio may result from a previously generated audio copy embedding a fingerprint-based watermark. Eventually, it may have been modified during distribution by one or more audio attacks such as MP3 compression, cropping, jittering, zeros inserting, additive white Gaussian noise (AWGN) and so on. An exemplary process flow for detecting an eventual embedded fingerprint-based watermark is shown in FIG. 4. In the following, we detail the implementation of the main components of this process namely Fingerprint Decoder and Watermark Decoder.

### Fingerprint Decoder

Its main purpose is to identify which audio master is associated to the unknown audio. Therefore, the fingerprints of the latter, denoted by f̅p̅ᵤₐ, are computed 203 and then matched to the fingerprints of all audio masters stored in the fingerprints database. If the matching process fails, then it is not possible to detect the potential embedded watermark. Otherwise, if there is a match then a master ID (m_IDⱼ) is returned 206 and used to retrieve the stored fingerprints f̅p̅ⱼ for that audio master.

### Watermark Decoder

An exemplary watermark decoder process 200 involves three main steps described below.

Reconstruct original watermarking zones. This operation is similar to the one of generating 209 watermarking zones (see above) during the process of embedding a watermark. Using m_IDⱼ to initiate the seed state, a pseudorandom number sequence is generated 220 and then used 223 to select a subset of f̅p̅ⱼ. Then, each selected fingerprint is mapped 226 to a time-frequency position to get the exact vector of original watermarking zones as follows

z̅ⱼ=[(t_{j,1}, f_{j,1}),(t_{j,2},f_{j,2}), . . . ,(t_{j,N}_{_{z}},f_{j,N}_{_{z}})] (4)

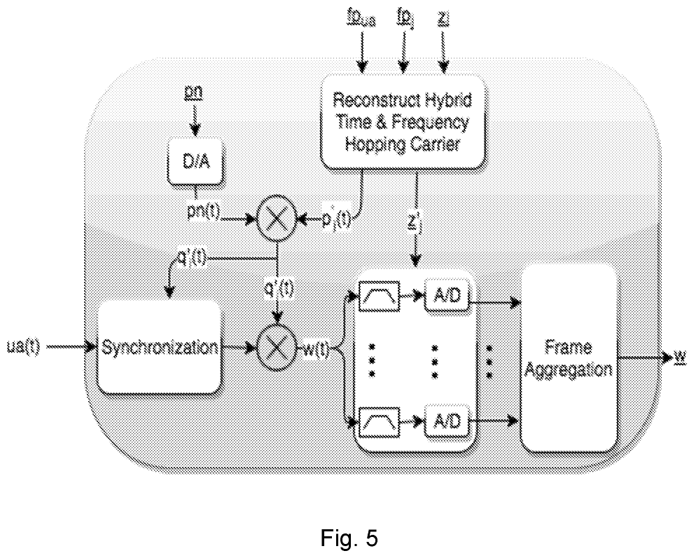

Watermark Extraction. The watermark extraction 212 operation is presented in FIG. 5. The first step is to reconstruct 230 the hybrid FH/TH carrier by exploiting the fingerprints of the unknown audio f̅p̅ᵤₐ and those of its associated master f̅p̅ⱼ to compute the time delay τ between them and identify the original watermarking positions that are available in the unknown audio.

Using the first index of watermark zone, nₛ, and the last index of the watermark zones, n_{f}, the vector of useful watermarking positions is represented by:

z̅′ⱼ=[(t_{j,n}_{ₛ}, f_{j,n}_{ₛ}),(t_{j,n}_{ₛ}₊₁,f_{j,n}_{ₛ}₊₁), . . . ,(t_{j,n}_{_{f}},f_{j,n}_{_{f}})] (5)

Thus, the resulting hybrid FH/TH carrier is given by the following expression

$${p}_{j}^{′} ( t ) = {\sum }_{n = {n}_{s}}^{{n}_{f}} {\int }_{{t}_{i , n} - \frac{Δ {T}_{i , n}}{2}}^{{t}_{i , n} + \frac{Δ {T}_{i , n}}{2}} {a}_{i , n} cos [ 2 π {f}_{i , n} ( t - τ - {t}_{i , n} ) ] \qquad ( 6 )$$

Note that by taking into account the time delay r in the carrier expression, this can be interpreted as a coarse synchronization between the carrier and the unknown audio.

Next, the reconstructed carrier is modulated 233 by the same pseudo-noise sequence (that has been used for generating copies) in order to get the spread spectrum FH/TH carrier q′ⱼ(t) . The latter is used to fine-tune the synchronization 236 between the carrier and the unknown audio by cross-correlating both signals. The synchronized unknown audio is then demodulated 239 using this spread spectrum FH/TH carrier q′ⱼ(t) to a get a baseband watermark signal w(t). The signal is then fed into a set of time-domain filters 242, which number is equal to the number of watermark positions found in the unknown audio. Each filter is defined by the time position of each watermarking positions in z̅′ⱼ and its time duration is equal to the duration of transmitting N_{bits}*R _{chip} at the frequency of each watermarking positions.

Finally, the different watermark payloads extracted from different frames may be aggregated 245 to get the maximum likelihood watermark payload w̅. The decoded watermark payload is encoded on N_{bits}. Its decimal value represents the audio copy number of the recognized master.

Parse Copy Information. With on the one hand the recognized master ID, m_IDⱼ, and the other hand the copy number, the information about the identified audio copy such as the master title, copy owner and so on are obtained from both audio master and copy metadata database.

Although the present disclosure has been described with respect to one or more particular embodiments, it will be understood that other embodiments of the present disclosure may be made without departing from the spirit and scope of the present disclosure. Hence, the present disclosure is deemed limited only by the appended claims and the reasonable interpretation thereof.

What is claimed is:

1. A method of generating a watermarked audio copy of an audio signal, comprising:
determining a vector of fingerprints of the audio signal;
determining, using fingerprint data of an audio database, a master ID and a saved fingerprint vector of the audio signal based on the determined vector of fingerprints;
generating watermark zones based on the master ID and the saved fingerprint vector;
creating a watermark payload based on the master ID and using copy metadata of the audio database;
embedding the watermark payload in the audio signal according to the watermark zones to create a watermarked audio copy of the audio signal.

2. The method of claim 1, wherein the master ID and saved fingerprint vector of the audio file is determined by:
checking for a fingerprint record within fingerprint data of an audio database which matches the determined vector of fingerprints, and retrieving a master ID of the matched record;
retrieving, from audio master metadata of the audio database, a saved fingerprint vector corresponding to the master ID;
storing, when no fingerprint record is matched, a new fingerprint record with a unique master ID; and
storing the master ID and the determined vector of fingerprints in the audio master metadata of the audio database.

3. The method of claim 1, wherein generating watermark zones comprises:
generating a pseudorandom number sequence using the master ID to initiate a seed state;
using the generated sequence to select a subset of fingerprints from the saved fingerprint vector; and
mapping each selected fingerprint of the subset of fingerprints to a time-frequency position to create a vector of watermark zones.

4. The method of claim 1, wherein creating the watermark payload comprises:
retrieving, from the copy metadata of the audio database, a number of existing copies of the audio signal;
encoding a next copy index number; and
storing the next copy index number in the copy metadata of the audio database.

5. The method of claim 1, wherein embedding the watermark comprises:
generating a hybrid frequency-hopping/time-hopping (FH/TH) carrier;
modulating the generated FH/TH carrier using a pseudo-noise sequence to create a spread spectrum FH/TH carrier;
modulating the spread spectrum FH/TH carrier using a watermark baseband signal to create a radiofrequency watermark signal; and
adding to the audio signal, the radiofrequency watermark signal to create the watermarked audio copy.

6. A method of retrieving information of an audio copy of an audio signal, comprising:
determining a vector of fingerprints of the audio copy;
determining, using fingerprint data of an audio database, a master ID and a saved fingerprint vector of the audio signal based on the determined vector of fingerprints of the audio copy;
generating watermark zones based on the master ID and the saved fingerprint vector of the audio signal;
extracting a watermark payload from the audio copy based on the master ID and the watermark zones; and
retrieving, using copy metadata of the audio database, information of the audio copy using the master ID and the extracted watermark payload.

7. The method of claim 6, wherein generating watermark zones comprises:
generating a pseudorandom number sequence using the master ID to initiate a seed state;
using the generated sequence to select a subset of fingerprints from the saved fingerprint vector; and
mapping each selected fingerprint of the subset of fingerprints to a time-frequency position to create a vector of watermark zones.

8. The method of claim 6, wherein extracting the watermark payload comprises:
reconstructing a hybrid frequency-hopping/time-hopping (FH/TH) carrier using the determined vector of fingerprints of the audio copy, the saved fingerprint vector of the audio signal, and the watermarking zones;
modulating the reconstructed FH/TH carrier using a pseudo-noise sequence to create a spread spectrum FH/TH carrier;
synchronizing the audio copy and the spread spectrum FH/TH carrier by cross correlation;
demodulating the synchronized audio copy using the spread spectrum FH/TH carrier to obtain a baseband watermark signal; and
filtering the baseband watermark signal, in the time domain, to extract a watermark payload for each watermarking zone.

9. The method of claim 8, further comprising aggregating the watermark payloads.
